(19) United States
(12) Patent Application Publication
(10) Pub. No.: US 2003/0110327 A1
(43) Pub. Date: Jun. 12, 2003

(54) Control method and device for maintain data integrity throughout transmission

(76) Inventors: Hung-Pin Chen, Shijr City (TW); Ching-Chung Lai, Taipei (TW)

Correspondence Address: RABIN & BERDO, P.C., Suite 500, 1101 14th Street, N.W., Washington, DC, 20005, US

(21) Appl. No.: 10/259,483

(22) Filed: Sep. 30, 2002

(30) Foreign Application Priority Data
Dec. 11, 2001 (TW) 090130713

(51) Int. Cl. G06F 13/00

(52) U.S. Cl. 710/33

(57) ABSTRACT

A control method of maintaining data integrity throughout transmission is provided. Firstly, a parameter value according to the value of a packet size of a packet is generated. The parameter value equals to the value of the packet size multiplied by a first value and added by a second value, and the denominator of the first value is a value of 2 to the power of an integer. Then, it is determined whether the parameter value is greater than a byte times left in a frame. If it is not, the packet can be transmitted. The invention can achieve purposes of less bandwidth, less cost, and simple circuit design.

This application incorporates by reference of Taiwan application Serial No. 901130713, filed Dec. 11, 2001.

### BACKGROUND OF THE INVENTION

1. Field of the Invention

This invention relates to a control method and a device for maintaining data integrity throughout transmission, and more particularly to a control method and a device for controlling a host controller of a Universal Serial Bus (USB) system.

2. Description of Related Art

The advantage of the USB is to be able to proceed with high-speed serial transmission between a host system and a USB device. A USB host controller in the host system is used for controlling transmission of data, which is transmitted to a USB device via the USB, and also for responding to the instructions delivered from a USB driver.

The host controller is mainly used for maintaining data integrity throughout transmission. Especially, when the bandwidth of the USB is insufficient, the host controller will not start the data transmission between the host system and the USB device. The data transmitted in the USB is in the form of frame. Each frame includes a number of data packets. For the standard of USB 1.1, the size of each frame is 1 msec (millisecond). For the standard of USB 2.0, the size of each frame is 0.125 msec. The starting point of frame is defined as Start of Frame (SOF), and the ending point of frame is defined as End of Frame (EOF). A data packet has to be transmitted completely within one frame, not to be extended to the next frame. When the host controller is informed by a driver to transmit a packet of a specific size, the host controller must detect the byte times left in a frame at that moment, in order to determine whether the bandwidth is sufficient for transmitting the packet, and then determine whether or not to start the packet transmission.

In the EHCI Revision 0.95 standard, on pages 59 and 60, a best-fit approximation algorithm is presented. The best-fit approximation algorithm approximates a last start curve using a function f(x), wherein the last start curve is a curve corresponding to the actual characteristic of USB data transmission. The host controller controls the transmission process by using the function f(x) approximating to the last start curve. The function f(x) represents the relation between the sizes of the packets and the byte times left in a frame. The function f(x) is mainly consisted of straight lines parallel to each other. When transmitting a packet of a specific size, the host controller firstly adds a constant on the value of the packet size, and then compares it with the byte times left in a frame according to the function f(x). If the comparing result is below the curve of the function f(x), the host controller will not start any transmission; if the comparing result is above the curve of the f(x), the host controller will start the transmission of the data packet. The better design of the function f(x) is the one that more accurately approximates the last start curve.

The conventional method will be described in the following, in which the traditional host controller uses best-fit approximation algorithm to determine whether or not to start the packet transmission, and to maintain data integrity throughout transmission. First, the host controller obtains the size value of the packet to be transmitted and the byte times left in the frame. Then, set a parameter value, which is equal to the value of the packet size plus 192. If the parameter value is greater than 128, the parameter value is added by 128. The parameter value represents the minimum byte times needed for transmitting the packet. After that, determine whether the parameter value is greater than the byte times left in the frame. If yes, then the host controller does not transmit this packet. If not, then the host controller transmits the packet.

However, in the best-fit approximation algorithm using traditional function f(x), when the size of a packet is smaller than 512 bytes, the difference between the function f(x) and the last start curve is greater than the difference when the packet size is greater than 512 bytes. When transmitting an EOF packet near the end of a frame, the host controller mostly applies asynchronous transfers. The sizes of packets transmitted via asynchronous transfer are normally smaller than 512 bytes. Therefore, it wastes more bandwidth when the best-fit approximation algorithm is applied with asynchronous transfers. Additionally, the circuit for applying the best-fit approximation algorithm must use at least two comparators and several adders. This results in high cost and is difficult to design. Therefore, it is necessary to develop a control method and device, with less bandwidth and less cost, to determine whether or not to start packet transmission in order to maintain data integrity throughout transmission.

### SUMMARY OF THE INVENTION

It is therefore an objective of the present invention to provide a control method of maintaining data integrity throughout transmission. It can also achieve the purposes of less bandwidth, less cost, and simple circuit design.

In accordance with the foregoing objective and other objectives of the present invention, the invention provides a control method of maintaining data integrity throughout transmission. It includes the following steps. Firstly, a parameter value according to the value of a packet size of a packet is generated. The parameter value equals to the value of the packet size multiplied by a first value and added by a second value, and the denominator of the first value is a value of 2 to the power of an integer. Then, it is determined whether the parameter value is greater than the byte times left in the frame. If it is not, the packet can be transmitted.

It is therefore an objective of the present invention to provide a control device for maintaining data integrity throughout transmission. The device is to receive a value of a packet size and a value of the byte times left in a frame. This device includes a shifting device, an adder, and a comparator. The shifting device is for shifting the value of the packet size. The adder is for adding a first value, the value of the packet size, and the parts of high bits of the packet size to generate a parameter value. Then, the comparator is for comparing the parameter value and the value of the byte times left in the frame. When the parameter value is smaller than the value of the byte times left in a frame, the packet can be transmitted.

### BRIEF DESCRIPTION OF DRAWINGS

The invention can be more fully understood by reading the following detailed description of the preferred embodiments, with reference made to the accompanying drawings, wherein:

FIG. 1 is a diagram of a function curve g(x) of this invention, a last start curve, and a curve of f(x) according to traditional best-fit approximation algorithm.

FIG. 2 illustrates a flowchart of a control method for maintaining data integrity throughout transmission according to the preferred embodiment of the invention.

FIG. 3 is a diagram of data transmission in a frame.

FIG. 4 illustrates a control device for maintaining data integrity throughout transmission according to the preferred embodiment of the invention.

### DETAILED DESCRIPTION OF PREFERRED EMBODIMENTS

Different from a traditional best-fit approximation algorithm, which uses a function f(x) with two lines, the invention uses a function g(x) with only one line to approximate the last start curve. When the packet size is smaller than 512 bytes, the curve of the function g(x) used in the invention is closer to the last start curve than the curve of the function f(x). As for asynchronous transfers, when the size of the packet to be delivered is smaller then 512 bytes, the invention can achieve the advantage of saving bandwidth, and the objectives of simplifying circuit design and reducing cost.

The function g(x) used in the invention is:

g(x)=(a/b)*x+Const (Eq. 1)

wherein “a/b” is the gradient of g(x), “x” represents a packet size, and “Const” is a constant.

In order to obtain the values of “a/b” and the constant “Const” of the function g(x), the last start curve at the worst-case packet overhead transfer must be found first. The finding method is to set all the data to be transmitted to be (hff)₁₆. In this situation, the amount of stuffing bits is maximum during data transmission. According to the rules in the standard, the transmitted data has to insert a stuffing bit after six continuous bits of logic 1. Thus, the gradient of the last start curve at the worst-case packet overhead transmit can be obtained, which is 7/6. And its intersecting point with the vertical axis is at 144 byte times. Therefore, for making the function g(x) approach to the last start curve, the value of “a/b” of the function g(x) of this invention must be greater than 7/6 and approximate to 7/6. The value of constant “Const” can be greater or equal to 144 and can be decided according to the actual situation.

However, if the value of “a/b” is equaled to 7/6, the circuit design corresponding to multiplication and division calculations is very complicated. Thus, for simplifying the circuit design, the value of “b” can be designed as a value of 2 to the power of an integer, (for example, 2^{N}, “N” is an integer) and the value of “a” can be a value of 2 to the power of an integer, or the sum of several numbers of 2 with an integral-number exponent. Since the value of “a/b” must greater than the gradient of the last start curve at the worst-case packet overhead transmit, which is 7/6, to give an example, the value of “b” can selected to be 8 and the value of “a” can selected to be 10. Then, for this example, the function g(x) of the invention is:

$$\begin{matrix}g ( x ) = ( 10 / 8 ) * x + 154 \\ = ( 1 + 1 / 4 ) * x + 154 \\ = ( 1 / 4 ) * x + x + 154\end{matrix} \qquad ( Eq . 2 )$$

wherein “x” is a binary value, so the calculation of “(1/4)* x” can be achieved by inputting “x” into a shifter. The result of dividing “x” by 4 is equal to shift “x” to right by 2 bits.

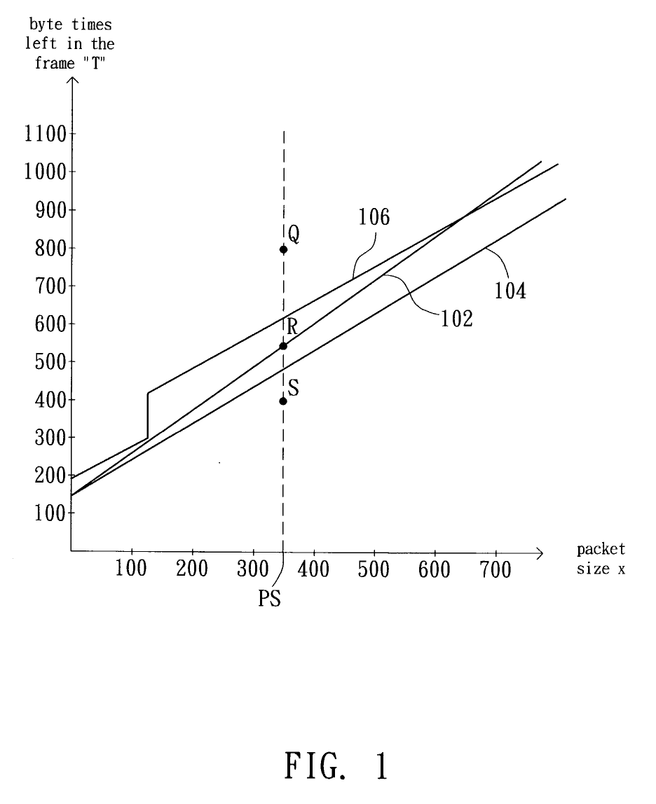

For further details, please refer to FIG. 1, which shows the function curve 102 of g(x) of the invention, the last start curve 104, and the function curve 106 of f(x) of a traditional best-fit approximation algorithm. The horizontal axis in FIG. 1 represents packet size x, and the vertical axis represents the byte times left in the frame “T”. Comparing the function g(x) of the invention with the traditional function f(x), when the packet size x is smaller than 512 bytes, the function g(x) of this invention can better approximate the last start curve 104.

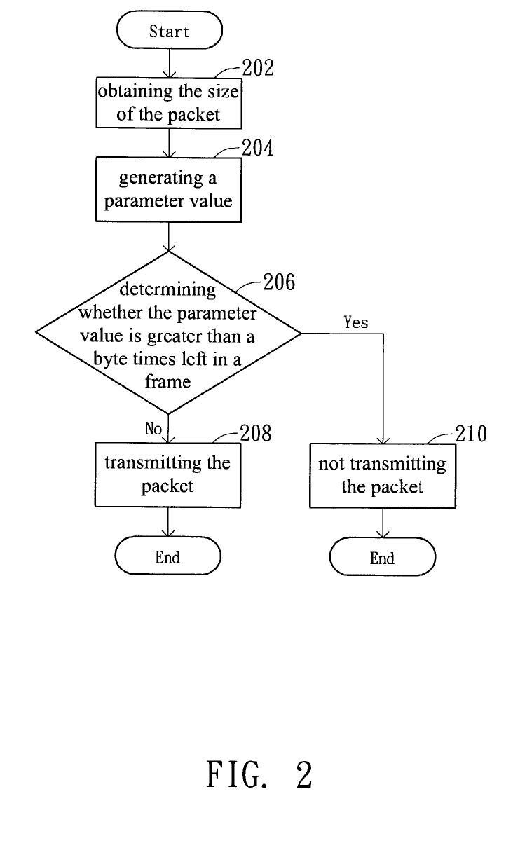

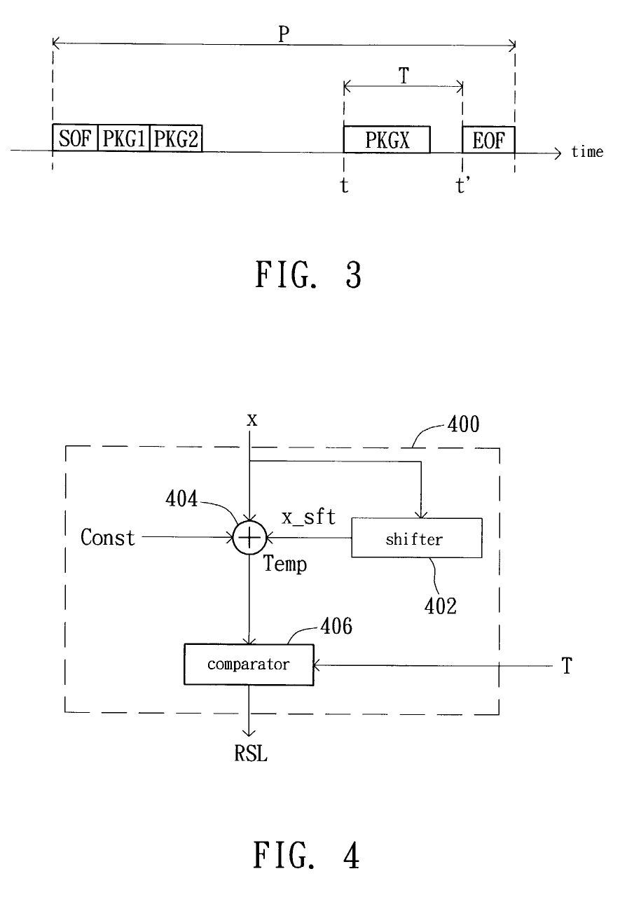

After determining the function g(x) of the invention, a flowchart of a control method for the maintaining data integrity throughout transmission according to the preferred embodiment of the invention is illustrated in FIG. 2. Please refer to FIG. 3 together, which is a diagram of data transmission in a frame. In FIG. 3, a period of frame is P, and the frame starts at the Start of Frame packet SOF, and ends at the End of Frame packet EOF. In the frame, the host controller has transmitted the packets PKG1and PKG2 in the USB.

When transmitting a packet PKGX via the USB at a time point t, the host controller applies the method of this invention according to the size “x” of packet PKGX and the byte times left in the frame “T”, and then determine whether or not the packet PKGX can be transmitted via USB, wherein the byte times left in the frame “T” is the difference between the present time point t and the time point t′ of EOF, an end of frame packet delivered by the host controller.

The steps that are applied by the host controller according to the method of this invention for maintaining data integrity throughout transmission are described as follows. Firstly, in the step 202, the host controller obtains the size “x” of the to-be-transmitted packet PKGX, which is to be PS, and obtains the byte times left in the frame “T” in the meantime. Then, in the step 204, a parameter value “Temp” according to the function g(x) is created as: Temp=g(PS)=(a/b)*PS+Const. The parameter value “Temp” represents the minimum byte times needed when transmitting the packet PKGX. In the step 206, it is determined whether the parameter value “Temp” is greater than the byte times left in the frame “T”. If it is not, then the method proceeds with the step 208, in which the host controller transmits the packet PKGX in the frame. If it is, the method proceeds with the step 210, and the host controller will not transmit the packet PKGX.

Please refer to FIG. 1. To give an example, assume the packet size is PS, and then the point on the function g(x) according to the generated parameter value “Temp” is R. At the moment when the host controller is going to transmit the packet PKGX, if the point to that the byte times left in the frame “T” corresponds is Q, which is above the point R, it means that the parameter value “Temp” is smaller than the byte times left in the frame “T”, which indicates that the USB has enough bandwidth at that time for the data transmission. So, the host controller would transmit the packet. However, at the moment when the host controller is going to transmit the packet PKGX, if the point to that the byte times left in the frame “T” corresponds is S, which is below the point R, it means that the parameter value “Temp” is greater than the byte times left in the frame “T”, which indicates that the USB does not have enough bandwidth for the data transmission. Therefore, the host controller would not transmit the packet.

The above equation, Eq. 2, can be rewritten as following:

g(x)=(1/2“N”)*x+x+Const. (Eq. 3)

In Eq. 3, the value of “N” is 2. However, the value of “N” can be varied according to different situations. The value of (1+1/2 “N”) must be greater than the gradient of the last start curve.

Based on the Eq. 3, a control device for maintaining data integrity throughout transmission according to the preferred embodiment of the invention is shown in FIG. 4. The control device 400 of the invention is applied in the host controller, and is used for receiving the value of a packet size “x”, and the value of the byte times left “T” in a frame. The control device 400 includes a shifter 402, an adder 404, and a comparator 406. The shifter 402 is used for shifting the binary value of the packet size “x” to right by “N” bits. The adder 406 is used for adding the constant value “Const”, the value of the packet size “x”, and the value of the packet size after being shifted “x_sft”, so that the parameter value “Temp” can be obtained. The comparator 406 is used for comparing the parameter value “Temp” and the byte times left in the frame “T”, and then for outputting the result “RSL”. When the parameter value “Temp” is smaller than the value of the byte times left in the frame “T”, then RSL is logic 1 (true), and the host controller would transmit the packet. When the parameter value “Temp” is greater than the value of the byte times left in the frame “T”, then RSL is logic 0 (false), and the host controller would not transmit the packet.

The shifter can also be substituted by a high bits extractor to achieve the same object. The high bits extractor is composed of logical units. The high bits extractor directly extracts parts of the high bits of the packet size “x”, removes the remaining low bits of the packet size “x”, and fills enough logic 0 from the end of most significant bit. Thus, the shift operation can be achieved by the high bits extractor as the shifter does.

Even though the above embodiment takes the value of “N” is 2 as an example for illustration, the gradient “a/b” of the function g(x) and the constant value “Const” in the invention can be adjusted according to the actual situation when applying the invention.

In summary, the above embodiment reveals a control method of maintaining data integrity throughout transmission, which can achieve the purposes of data transmission with small bandwidth, at less cost, and via a simple circuit design.

The invention has been described using exemplary preferred embodiment. However, it is to be understood that the scope of the invention is not limited to the disclosed embodiment. On the contrary, it is intended to cover various modifications and similar arrangements. The scope of the claims, therefore, should be accorded the broadest interpretation so as to encompass all such modifications and similar arrangements.

What is claimed is:

1. A control method of maintaining data integrity throughout transmission, said method comprising the steps:
generating a parameter value according to the value of a packet size of a packet, wherein said parameter value equals to the value of said packet size multiplied by a first value and added by a second value, and the denominator of said first value is a value of 2 to the power of an integer; and
determining whether said parameter value is greater than a byte times left in a frame, wherein if it is not, said packet can be transmitted.

2. The control method according to claim 1, wherein said first value is a constant.

3. The control method according to claim 1, wherein said second value is a constant.

4. The control method according to claim 1, wherein said method is applied to in a host controller of a Universal Serial Bus (USB) system, wherein said USB system is corresponding to a last start curve, and said first value is greater than the gradient of said last start curve.

5. The control method according to claim 1, wherein the numerator of said first value is a value of 2 to the power of an integer or sum of values of 2 to the power of an integer.

6. A control method of maintaining said data integrity throughout transmission, wherein said method is applied to a host controller of a Universal Serial Bus (USB) system, and said USB is corresponding to a last start curve, said method comprising the steps:
generating a parameter value according to the value of a packet size of a packet, wherein said parameter value equals to the value of a packet size multiplied by a first constant and added by a second constant, and the denominator of said first constant is a value of 2 to the power of an integer, and the numerator of said first constant is a value of 2 to the power of an integer or sum of values of 2 to the power of an integer; and
determining whether said parameter value is greater than byte times left in a frame, wherein if it is not, then said packet can be transmitted.

7. A control device for maintaining data integrity throughout transmission, for receiving a value of a packet size and a value of said byte times left in a frame, comprising:
a shifting device for shifting the value of said packet size;
an adder for adding a first value, the value of said packet size, and the parts of high bits of said packet size to generate a parameter value; and
a comparator for comparing said parameter value and the value of said byte times left in said frame;
wherein when said parameter value is smaller than the value of said byte times left in said frame, said packet can be transmitted.

8. The control device according claim 7, wherein said shifting device is implemented by a shifter.

9. The control device according claim 7, wherein said shifting device is implemented by a high bits extractor for extracting parts of the high bits of the value of said packet size, and removing said remaining low bits.

10. The control device according claim 8, wherein the value of said packet size is a binary value, and said shifter is a shifter for shifting the value of said packet size right by “N” bits, N is an integer.

11. The control device according claim 10, wherein said value of “N” is 2.

12. The control device according claim 11, wherein said device is applied to a host controller of a Universal Serial Bus (USB) system, and said USB is corresponding to a last start curve, and said value of (1+1/2^{N}) is greater than the gradient of said last start curve.

13. The control device according claim 8, wherein said first value is a constant.
